(19) United States
(12) Patent Application Publication
(10) Pub. No.: US 2010/0005452 A1
(43) Pub. Date: Jan. 7, 2010

(54) Methods and systems for factory configuration of existing customer system settings

(76) Inventors: Douglas M. Anson, Dripping Springs, TX (US); Richard W. Schuckle, Austin, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 12/217,578

(22) Filed: Jul. 7, 2008

(51) Int. Cl. G06F 9/44

(52) U.S. Cl. 717/121

(57) ABSTRACT

Methods and systems are described for factory configuration of existing customer settings so that existing customer settings can be easily configured or pre-configured on new information handling systems. A software module is run on a first information handling system that captures configuration information for an existing information handling system. One example for such configuration information is network configuration information associated with one or more existing wireless and/or wired networks on which a new information handling system will operate. Captured configuration information is transferred to a server information handling system associated with ordering of the new information handling system. The transferred configuration information is then used to configure the new information handling system.

### TECHNICAL FIELD

The present invention relates to the configuration of system settings and, more particularly, to the configuration of customer system configuration settings for newly acquired information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Currently, a user purchasing or acquiring a new information handling system must typically configure the settings onto the new system once the new system is physically received by the user. In particular, current configuration processes often require installation of software utilities or wizards to copy over settings directly from a previous system to the newly acquired system. In addition, with respect to wireless network settings, current methods of configuring a new system often require a wireless user to connect to a router or other system in a wired fashion in order to gain access to the user's wireless settings. The user's wireless settings are then transferred onto the user's new system to enable wireless networking with the new information handling system. One significant disadvantage of these current techniques, however, is that the user is not able to connect to the wireless network without first connecting through a wired network to obtain wireless network settings or manually entering those wireless settings.

### SUMMARY

Methods and systems are described herein for factory configuration of existing customer settings so that existing customer settings can be easily configured or pre-configured on new information handling systems. As further described herein, a software module is run on a first information handling system that captures configuration information for an existing information handling system. One example for such configuration information is network configuration information associated with one or more existing wireless and/or wired networks on which a new information handling system will operate. Captured configuration information is transferred to a server information handling system associated with ordering of the new information handling system. The transferred configuration information is then used to configure the new information handling system. As described below, other features and variations can be implemented, if desired, and related systems and methods can be utilized, as well.

### DESCRIPTION OF THE DRAWINGS

It is noted that the appended drawings illustrate only exemplary embodiments of the techniques described herein and are, therefore, not to be considered limiting of its scope, for the techniques may admit to other equally effective embodiments.

FIG. 1 is a block diagram of an environment for factory configuration of existing customer settings for new information handling systems.

FIG. 2 is a flowchart for configuring wireless network settings on a new system where the user is ordering the new system through a network connection on the network on which the new system will operate.

FIG. 3 is a flowchart for configuring wireless network settings on a new system where the user is ordering a new system through a network connection on a network that is different from the network on which the new system will operate.

FIG. 4 is a flowchart for configuring wireless network settings on a new system where the user is obtaining a new system through a non-network connection, such as through a retail site.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a server computer system, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Methods and systems are disclosed for factory configuration of existing customer settings so that these settings can be configured on newly acquired information handling systems without requiring a customer to go through complicated transfer procedures. For example, as described herein, the transfer of wireless settings for existing system environments to a newly acquired system can be accomplished by running a software module that captures a user's network configuration information from a current computer system. This configuration information can then be transferred by the software module to the computer manufacturer. The manufacturer can then perform a factory configuration of a new system with the user's current configuration information, including wireless network configuration information. As such, the new system can be preloaded or preconfigured with the captured configuration information. With respect to wireless network configuration information, this pre-configuration allows the new system to connect to the customer's existing wireless networks without the customer having to manually input wireless settings and/or use a complicated wired transfer process to move network settings to the new system. Alternatively, where the new system is acquired by the customer in a non-networked environment, such as from a retail store or site, the configuration of the new system can occur after the user has already taken possession of the new system through a download of the configuration information by the user from the computer manufacturer to the new computer system. Still further, if the configuration information is stored by the manufacturer, the user can download this information at any desired point in the future. This option could be useful, for example, where a user has had to reload software and/or operating systems onto a system, such as when a hard drive fails. It is further understood that the terms “customer” and “user” are used interchangeably herein and are intended to refer generically to any person or entity that is acquiring a new information handling system. As described below and as would be understood by one of skill in the art, other features and variations can be implemented, if desired, and related systems and methods can be utilized, as well.

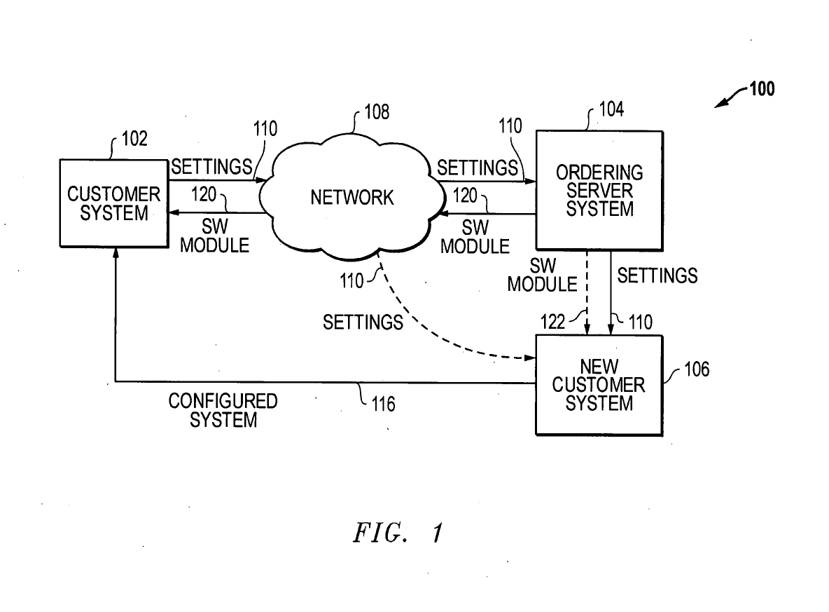

FIG. 1 shows an environment 100 for configuring existing customer settings on newly acquired information handling systems. As depicted, a customer connects to an ordering server system 104 through a network 108 using a customer system 102. The network 108 can be any number of networked systems, including the Internet, that provide for wired and/or wireless communications between the customer system 102 and the ordering server system 104. For example, a customer's information handling system 102 may be wirelessly coupled to a wireless local area network (WLAN) through a wireless access point (WAP). This WLAN can further have a broadband wide area network (WAN) connection to an internet service provide (ISP), such as through a DSL (digital subscriber line) or cable modem. Internet access can thereby be provided to systems on the WLAN. The ordering server system 104 can be any of a number of different information handling systems that provide network-based ordering and/or acquisition of information handling systems. For example, the ordering server system 104 can be one or more computer servers that are also connected to the Internet through local area networks (LANs) and/or WAN connections to thereby provide on-line ordering or system acquisition to Internet connected systems. Typically, Internet based server systems will be accessible through an appropriate URL (uniform resource locator) to other Internet connected systems.

As described herein, a customer desiring to acquire a new information handling system 106 can streamline the process of configuring this newly acquired information handling system 106 for operation through the techniques described herein for capturing and transferring configuration information. In general, configuration information for the new information handling system is captured using a software module. This configuration information is then transferred to the system manufacturer or provider through network connections. The manufacturer or system provider can then preload the settings on the new system and/or make the settings available for download to the new system at a later time. In this way, the user can rapidly operate the new system according to previously existing customer system settings. With respect to wireless networks, this process allows for a new information handling system to be configured to existing wireless network settings without requiring the user to manually set the network configuration settings or use more complicated wired transfer procedures.

The configuration information captured from existing information handling systems and used to configure new information handling systems includes a wide variety of configuration information associated with the existing information handling system. Although network configuration settings, and wireless configuration settings more particularly, are discussed below, it is understood that the configuration information is not limited to network configuration information or wireless network configuration information. For example, the configuration information can include Bluetooth configuration information for one or more Bluetooth devices paired with an existing information handling system. The configuration information can also include wireless wide area network configuration information for an existing wide area network associated with the existing information handling system. Further, the configuration information can include other non-network related configuration information for the existing information handling system, such as desktop settings, screen background settings, graphical user interface themes and settings, application settings and/or other configuration settings associated with an existing information handling system. In short, using the systems and methods described herein, a user can streamline the process of configuring a new information handling system with settings associated with an existing information handling system by capturing those settings, transferring them to a server system associated with the ordering of the new system, and later configuring the new system with those captured and transferred settings.

It is noted, however, that the techniques described herein are particularly helpful for transferring wireless network configuration information because wireless networks typically have complicated setup requirements. With wired networks, for example, if the new system has a wired network port, it is often enough for simple networks to attach a network cable between the network port on the new system and the existing wired network port (e.g., typically in the wall). For larger corporations where network access is limited to specific systems, this process may be more complicated. However, many homes and businesses use access requirements of user names and passwords. As such, plugging into existing wired connections may be enough, as long as the user knows his/her user name and password. However, with wireless networks, configuration typically requires at least an SSID (service set identifier) and often wireless encryption settings such as WEP (Wired Equivalent Privacy) and/or WPA (Wi-Fi Protected Access). In addition, for portable computer systems in particular, a user may have many different wireless networks that have stored network settings within the system (e.g., wireless networks used at home, business, coffee shops, restaurants, hotels, etc.). Advantageously, one or more of these wireless network configurations can be captured, transferred to an internet connected server, and then preloaded on a new system and/or later downloaded to the new system. These techniques, therefore, significantly limit the amount of re-configuration required by the user when the user obtains a new system, particularly for connection to wireless networks that have access restrictions.

Looking back to FIG. 1, the operation of the systems within environment 100 is now further described. Upon request and/or approval by the customer system 102, a software (SW) module 120 is downloaded from the ordering server system 104 to the customer system 102. The software module 120 is then used to obtain network configuration information or settings, such as wired and wireless network settings. As depicted, customer system 102 transfers the configuration settings 110 through the network 108 to the ordering server system 104. Once transferred to the ordering server system 104 of the manufacturer, these settings 110 can then be used to configure a new customer system 106 for the customer.

As indicated above, and as described in more detail below, these settings 110 can be provided to the new customer system 106 using a variety of techniques. One of these techniques is for the manufacturer to preload the new customer system 106 with the settings 110. The configured system can then be provided to the customer as represented by line 116. Another technique discussed in more detail below is for a software module 122 to be downloaded to the new customer system and for the settings 110 to be downloaded from the server system 104 through the network 108. Still further, the manufacturer can store one or more sets of settings 110 and then provide them for download at a later time to one or more newly acquired systems based upon user selections. In addition, these sets of saved configuration information can be downloaded for use in reconfigured systems, for example, a system that has been moved from one network environment to another, and/or systems that have had to be reloaded with software, for example, due to a hard drive failure. It is further noted that the software module 120 and the software module 122 can be configured to be the same software module, if desired.

If the settings 110 are preloaded onto the new customer system 106 prior to its being shipped or provided to the customer, then the customer is able to use the new system without further configurations being necessary. As discussed above, this preloading of configuration information is particularly advantageous for wireless networks in that the newly acquired system already has the wireless settings for the wireless network or networks on which the user desires the newly acquired system to operate. Alternatively or in addition, the user can download settings 110 to the new system at a later time, for example, where the new system is purchased through a non-networked ordering environment, such as through a retail store or site, or where a new system is being reloaded with software and/or configuration information.

The software module 120 can be a software module that can be downloaded through the network 108 from the ordering server system 104 and/or from any other desired system. The purpose of this software module 120 is to provide a automated process through which configuration information, and wireless settings in particular, can be gathered with respect to a current system. For example, the software module can be operated on a current customer system to capture network settings for networks to which the system is currently connected. In addition, the software module can capture network settings for network information that is stored on the customer system. For example, some operating systems and network utilities store wireless access information for wireless networks to which the system has connected in the past. The software module can capture these network settings, as well, even though the system is not currently connected to these other wireless networks. The user can then connect to the ordering server system 104 and/or another server system through the network 108, and the software module can transfer the network configuration information to the manufacturer or system provider for use in configuring the new customer system 106.

It is again noted that the settings 110, as depicted in FIG. 1, represent any desired configuration information for an existing information handling system that is to be used to configure a new information handling system. With respect to network configuration information, the settings 110 can relate to any desired network to which the new customer system 106 is desired to be connected. As such, the network configuration information obtained and transferred to the server system 104 can be wired settings and/or wireless settings associated with one or more networks, as desired. In addition, it is noted the new customer system 106 represents any system that is being newly acquired by the customer through a manufacturer or system provider and is not limited to a system for which the customer is the first purchaser of the system. In addition, the new customer system 106 also refers to any system that is being reloaded or reconfigured with configuration information so that its operation is being renewed. As used herein, therefore, the new information handling system that is being configured with the captured configuration information includes any system that is being configured with the captured and transferred configuration information.

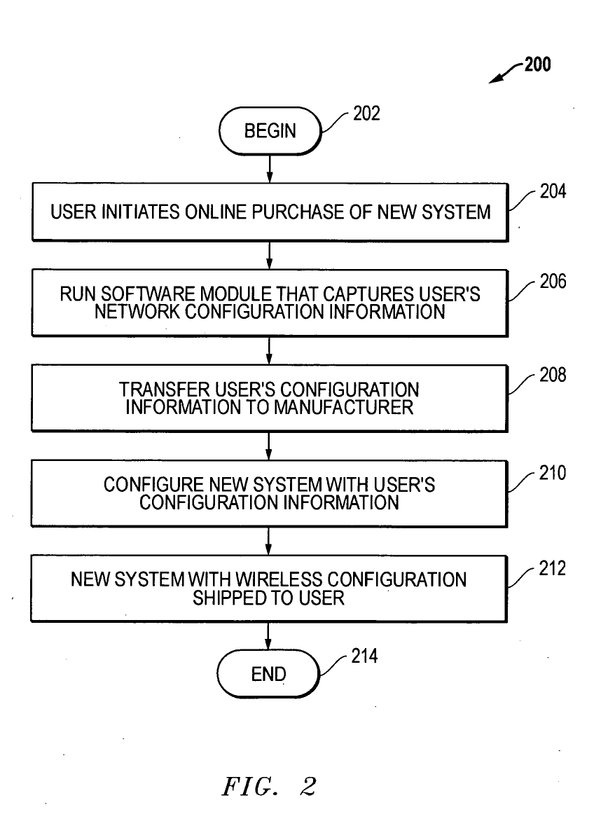

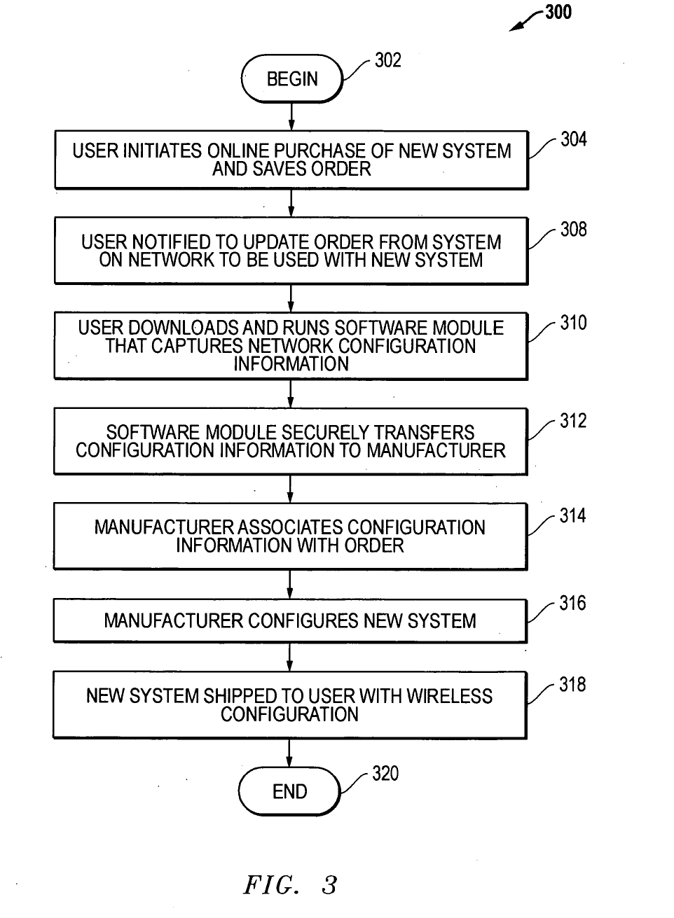

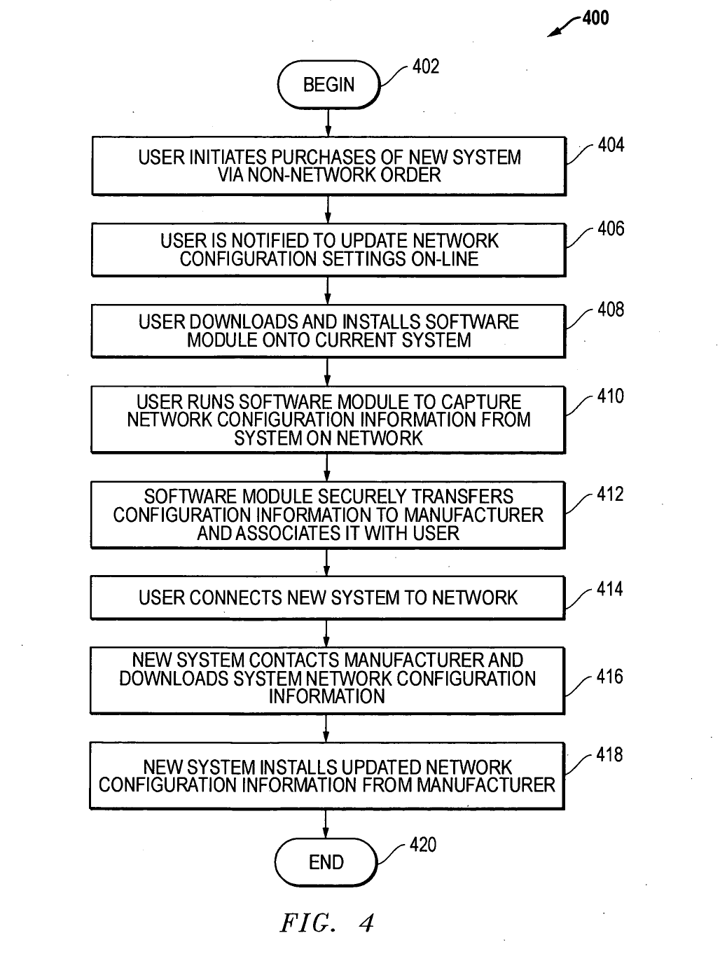

FIG. 2, FIG. 3 and FIG. 4 are now discussed. Each of these provide different techniques for providing network settings to the new system. While FIG. 2, FIG. 3 and FIG. 4 are directed to capturing and transferring network configuration information, these same processes can be used more generally with any configuration information being captured with respect to the existing information handling systems and transferred to server systems for later use in configuring new information handling systems.

As depicted, FIG. 2 can be used where the user is ordering a new system through a network connection to which the new system will connect. FIG. 3 can be used where the user is ordering a new system through a network connection separate from the one to which the new system will connect. And FIG. 4 can be used where the user is ordering a new system through a non-network path, such as through a retail site or store. It is further noted that other variations could also be used, as desired, for configuring a new customer system with network configuration information captured by the customer and transferred to the manufacturer or provider of the new system.

FIG. 2 is a flowchart of a process 200 for configuring wireless network settings on a new system where the user is ordering the new system through a network connection on the network on which the new system will operate. The process begins in block 202. In block 204, a user initiates purchase of a new system. In block 206, the user runs a software module, such as a software application or software plug-in, that captures network configuration information related to the current system and the network to which it is connected. As indicated above, the software module can be downloaded from a server system to the customer's system. In addition, if desired, the software module can encrypt the network configuration information being captured in order to help ensure secure transfer of the user's network configuration information. If the user is not on the network on which the new personal computer will be used, the user can be asked to update the user's order from a system on the network that will be used. This process is discussed with respect to FIG. 3 below. In block 208, the software module is used to transfer, preferably in a secure fashion, the network configuration information to the system manufacturer. In block 210, the system manufacturer configures the new system with the user's network configuration information. In block 212, the new system with the preloaded wireless configuration is shipped to the user. The process ends in block 214. When the user receives and operates the new system, the network configuration settings will already be loaded such that network access will be available to the new system and, in particular, wireless network access will be available to the new system.

It is noted that the system manufacturer can also store the customer network configuration information for future orders or downloads by the user. For example, when a new order is received from the user, the user can be given the option to select from previously stored sets of network configuration information. As such, if a user selects to use previously stored network configurations, the manufacturer can configure the user's next ordered system with the user's previously stored network configuration information. This additional system can then be shipped to the user with wireless and/or wired network configurations preloaded. In addition, this stored network configuration information can be downloaded by the user at a later time.

FIG. 3 is a flowchart of a process 300 for configuring wireless network settings on a new system where the user is ordering a new system through a network connection on a network that is different from the network on which the new system will operate. The process begins in block 302. In block 304, the user initiates an on-line purchase of a new computer system through a network that is different from the network on which the new system will operate, and the user then saves the order, typically on the manufacturer's ordering system. In block 308, the user is then notified to update the order with the network settings for the intended network to be used with the new system. In block 310, the user downloads and runs a software module, such as an applet or plug-in, from the manufacturer's server to capture the network configuration information for the network on which the new system will operate. When captured by the software module, the network configuration information can be encrypted, if desired, to help ensure secure transfer of the network configuration information. In block 312, the software module securely transfers the configuration information to the manufacturer. In block 314, the manufacturer associates the network configuration information with the user's online order for the new system. It is noted that the user can identify or select the order number when updating the network configuration settings. In block 316, the manufacturer configures the new system with the captured network configuration information. In block 318, the new computer system is shipped or provided to the user with the preloaded network configuration information, including wireless network configuration information. The process ends in block 320.

It is further noted that the user can also be provided an option to use previously saved network configuration information, if desired, rather than updating the order at a later time. This option could be provided to the user prior to block 308. If the user selects to use previously saved network configuration information, then the user can be provided an option to select a set of saved settings to associate with the current order. Flow can then pass to block 314 where the saved settings are associated with the order. This ability to save network configuration information, including wireless network configuration information, with the manufacturer can significantly streamline the system build process, particularly where the use may be ordering a number of different systems for use on the same wireless networks and/or wired networks.

FIG. 4 is a flowchart of a process 400 for configuring wireless network settings on a new system where the user is obtaining a new system through a non-network connection, such as through a retail site. The process begins in block 402. In block 404, the user initiates purchase of a new system via a non-network order, such as a retail purchase. In block 406, the user is notified to update network configuration settings on-line. In block 408, the user downloads and installs a software module onto a current system. In block 410, the user runs the software module to capture network configuration information from the network on which the current system is operating. As above, the gathered network configuration information can be encrypted to help ensure secure transfer of the network configuration information. In block 412, the software module securely transfers the network configuration information to the manufacturer, and the network configuration information is associated with the user and/or the user's non-network initiated order. In block 414, the user then connects the new system to the network. The new system then contacts the manufacturer and downloads the network configuration information associated with the user. In block 418, the new system installs the updated network configuration information that was obtained from the manufacturer. The process ends in step 420.

It is noted that the software module can be configured to step the user through each of these steps in obtaining current network configuration information, associating the network configuration with a new system being ordered, and to load the network configuration settings on the new system. It is also noted that for process 400, the software module will likely be downloaded to an existing system in order to obtain current network configuration settings and then downloaded from the manufacturer to the new system in order to obtain the saved network configuration settings for application to the new system.

For each of these ordering processes, the network configuration settings can be obtained from networks to which a system is currently connected and/or from networks for which the system has saved network configuration settings. For example, as indicated above, a portable computer system, or other information handling system, may have been connected to a number of different wired and/or wireless networks, and the system may have stored network configuration settings for these networks. The software module, if desired, can be configured to capture this previously stored network configuration information from the system itself. As such, the user would not need to obtain network settings from a system connected to the desired network of operation for the new system. Rather, the user could simply run the software module on a system having network settings that the user would like to have installed on the new system. Once obtained, these network settings could be transferred to and stored by the manufacturer's server systems through a network connection. These stored network configuration settings can then be associated with user orders whether they occur through a direct on-line purchasing system or through a non-network channel, such as through a retail sale in an electronics store.

Further modifications and alternative embodiments of the techniques described herein will be apparent to those skilled in the art in view of this description. It will be recognized, therefore, that the techniques described herein are not limited by these example arrangements. Accordingly, this description is to be construed as illustrative only and is for the purpose of teaching those skilled in the art the manner of carrying out the techniques described herein. It is to be understood that the forms of the techniques described herein shown and described are to be taken as the presently preferred embodiments. Various changes may be made in the implementations and architectures. For example, equivalent elements may be substituted for those illustrated and described herein and certain features of the techniques described herein may be utilized independently of the use of other features, all as would be apparent to one skilled in the art after having the benefit of this description of the techniques.

What is claimed is:

1. A method of configuring settings on a new information handling system, comprising:
running on a first information handling system a software module that captures configuration information for an existing information handling system;
transferring the configuration information through a network to a server information handling system associated with ordering new information handling systems; and
configuring a new information handling system with the transferred configuration information.

2. The method of claim 1, wherein the configuring step is conducted by a system manufacturer and further comprising providing the new information handling system from the system manufacturer to a customer after the configuring step.

3. The method of claim 1, further comprising initiating an order through the network with the first information handling system and downloading the software module to the first information handling system from the server information handling system, wherein the network comprises the Internet.

4. The method of claim 1, wherein the configuration information comprises wireless network configuration information for one or more existing wireless networks.

5. The method of claim 4, wherein the configuration information further comprises wired network configuration information.

6. The method of claim 4, wherein the first information handling system is connected to a wireless network on which the new information handling system will operate and wherein the configuration information comprises wireless settings associated with the wireless network on which the new information handling system will operate.

7. The method of claim 1, further comprising initiating an order through the network with a second information handling system not connected to a network on which the new information handling system will operate, wherein the network comprises the Internet.

8. The method of claim 7, further comprising downloading the software module to the first information handling system from the server information handling system prior to the running step.

9. The method of claim 1, wherein the configuration information comprises Bluetooth configuration information for one or more Bluetooth devices paired with the existing information handling system.

10. The method of claim 1, wherein the configuration information comprises wireless wide area network configuration information for an existing wide area network.

11. The method of claim 1, wherein the configuration information comprises non-network related configuration information for the existing information handling system.

12. The method of claim 1, further comprising prior to the running step, initiating an order through a non-network path and subsequently downloading the software module to the first information handling system from the server information handling system, wherein the network comprises the Internet.

13. The method of claim 12, further comprising after the transferring step, storing the wireless network configuration information with the server information handling system and then prior to the configuring step, downloading the configuration information to the new information handling system.

14. The method of claim 13, wherein the non-network path comprises a retail store.

15. The method of claim 1, further comprising storing the configuration information after the transferring step and wherein the configuring step uses the stored configuration information.

16. The method of claim 15, further comprising allowing a user to select from one or more sets of stored configuration information for the configuring step.

17. The method of claim 1, wherein the network comprises the Internet.

18. A system for configuring settings on a new information handling system, comprising:
a server information handling system coupled to a network and configured to receive configuration information from a plurality of first information handling systems; and
a software module associated with the server information handling system and configured to be downloaded upon request to each of the first information handling systems, the software module configured to capture configuration information for an existing information handling systems and to transfer the captured configuration information to the server information handling system for each first information handling system.

19. The system of claim 18, wherein the configuration information comprises wireless network configuration information for one or more existing wireless networks.

20. The system of claim 18, wherein a new information handling system is configured with the captured configuration information for each of the first information handling systems.

21. The system of claim 18, wherein the server information handling system is configured to store the configuration information for later use in configuring new information handling systems.

22. The system of claim 18, wherein the network comprises the Internet.
